(19) United States
(12) Patent Application Publication
(10) Pub. No.: US 2009/0003138 A1
(43) Pub. Date: Jan. 1, 2009

(54) Calendar interface scheduling tool for a data acquisition system

(75) Inventors: Aaron Michael Donnelli, Metamora, IL (US); Daniel Craig Wood, East Peoria, IL (US); Anthony Dean McNealy, Peoria, IL (US); Alan Lewis Ferguson, San Jose, CA (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/819,886

(22) Filed: Jun. 29, 2007

(51) Int. Cl. G04C 17/00

(52) U.S. Cl. 368/28

(57) ABSTRACT

A data acquisition system is disclosed. The data acquisition system includes one or more remote machines, and an off-board system in communication with the one or more remote machines. The off-board system is configured to display a calendar interface having a plurality of selectable entries each corresponding to a different period of time, receive a user's selection of one of the plurality of selectable entries corresponding to a desired period of time, receive a user's selection of one of the one or more remote machines, and receive a user's selection of one of a plurality of available operational parameters monitored by the selected one of the one or more remote machines. The off-board system is further configured to update a configuration of the selected one of the one or more remote machines based on the desired period of time and the selected one of a plurality of available operational parameters.

### TECHNICAL FIELD

The present disclosure relates generally to a data acquisition system, and more particularly, to a calendar graphical user interface scheduling tool for use with a data acquisition system.

### BACKGROUND

Conventional equipment scheduling systems employ a computer-based system that allows a user to control various resources and equipment assigned to the system. For example, the scheduling system may be associated with a building or group of buildings and allow a user to program the scheduling system to automatically control certain resources (e.g., lighting) in the building(s).

One such system is described in U.S. Pat. No. 6,073,110 (the '110 patent) by Rhodes et al., issued on Jun. 6, 2000. In particular, the '110 patent describes a computer-based equipment scheduling system used to schedule automatic operation of building equipment such as heating, air conditioning, and blowers. A user can define certain parameters of an activity (e.g., basketball game), such as a duration of the activity, zones of a building in which the activity will take place, the particular resources to be used during the activity, and other parameters associated with the activity. The scheduling system provides a calendar interface, wherein the user can schedule the defined activity by “dragging and dropping” the defined activity onto a desired day or days of the month to indicate when the activity is occurring on that day. In response to the scheduling of the activity, the system will automatically control the building resources in accordance with the defined parameters associated with the activity.

Although the scheduling system of the '110 patent may sufficiently control building resources for a specific activity, it may not provide the user with important information relating to usage of the resources. Specifically, the system does not allow the user to schedule the retrieval of performance and/or diagnostic information about resources. Efficient scheduling of the usage of a heating or cooling system in a particular zone of a building during a particular event may be rendered ineffective if that system requires maintenance, has failed, or otherwise is not functioning properly. Further, the scheduling system of the '110 patent does not allow the user to view, trend, compare or otherwise analyze the past usage of the building resources. As such, the user may be unable to efficiently diagnose problems that arise in connection with the usage of the resources, and plan for the future as to minimize or prevent these problems.

The disclosed calendar interface scheduling tool is directed to overcoming one or more of the problems set forth above.

### SUMMARY OF THE INVENTION

One aspect of the present disclosure is directed to a data acquisition system. The data acquisition system may include one or more remote machines and an off-board system in communication with the one or more remote machines. The off-board system may be configured to display a calendar interface having a plurality of selectable entries each corresponding to a different period of time, receive a user's selection of one of the plurality of selectable entries corresponding to a desired period of time, receive a user's selection of one of the one or more remote machines, and receive a user's selection of one of a plurality of available operational parameters monitored by the selected one of the one or more remote machines. The off-board system may be further configured to update a configuration of the selected one of the one or more remote machines based on the desired period of time and the selected one of a plurality of available operational parameters.

Another aspect of the disclosure is direct to a method of acquiring data. The method may include displaying a calendar interface having a plurality of selectable entries each corresponding to a different period of time, receiving a selection of a one of the plurality of selectable entries corresponding to a desired period of time, receiving a selection of one of the one or more remote machines, and receiving a selection of one of a plurality of available operational parameters monitored by the selected one of the one or more remote machines. The method may further include updating a configuration of the selected one of the one or more remote machines based on the desired period of time and the selected one of a plurality of available operational parameters.

### BRIEF DESCRIPTION OF THE DRAWINGS

FIG. 1 is a diagrammatic and schematic illustration of an exemplary disclosed data system;

FIG. 2 is a diagrammatic illustration of an off-board control system for use with the data system of FIG. 1;

FIG. 3 is a graphical representation of an exemplary disclosed graphical user interface (GUI) for use with the data acquisition system of FIG. 1.

FIG. 4 is a graphical representation of an exemplary disclosed selectable entry of the GUI of FIG. 3.

### DETAILED DESCRIPTION

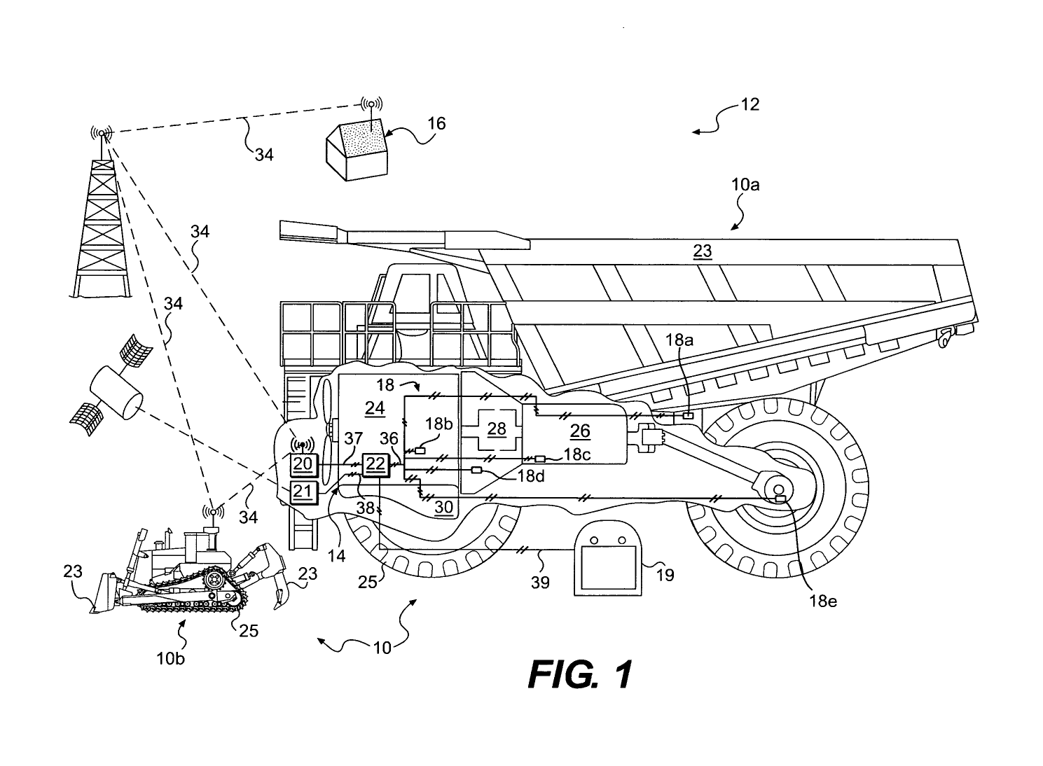

FIG. 1 illustrates an exemplary disclosed data system 12 for use with one or more machines 10. Each machine 10 may embody a stationary or mobile machine configured to perform some type of operation associated with an industry such as mining, construction, farming, transportation, power generation, or any other industry known in the art. For example, machine 10 may be an earth moving machine such as an on or off-highway haul truck 10a, a dozer 10b, a loader, a backhoe, an excavator, a motor grader, or any other earth moving machine. Machine 10 may alternatively embody a stationary generator set, pumping mechanism, or other suitable operation-performing machine.

Data system 12 may include subsystems that communicate to automatically gather and report information from machine 10 during operation. For example, data system 12 may include an onboard data collection system 14 associated with each machine 10, and a central off-board control system 16. It is contemplated that multiple off-board control systems 16 may alternatively be implemented, if desired.

Each onboard data collection system 14 may include an interface module 18, an operator interface 19, a communication module 20, a locating device 21, and a controller 22 configured to communicate, via communication module 20, with off-board control system 16 and/or the communication module of one or more remote machines 10b. It is contemplated that one or more of interface module 18, communication module 20, and controller 22 may be integrated as a single unit, if desired. It is further contemplated that onboard data collection system 14 may include additional or different components than those illustrated within FIG. 1.

Interface module 18 may include a plurality of sensing devices 18a-e distributed throughout machine 10 and configured to gather data from various components, subsystems, and/or operators of machine 10. Sensing devices 18a-e may be associated with, for example, a work implement or tool 23, a power source 24 (to power operations of machine 10), a traction device 25 (coupled to power source to propel machine 10), a transmission 26, a torque converter 28, a fluid supply 30, a suspension system (not shown), operator interface 19, and/or other components and subsystems of machine 10. These sensing devices 18a-e may be configured to automatically gather operational information from the components and subsystems of machine 10 including implement, engine, and/or machine speed or location; fluid (i.e., fuel, oil, etc.) pressures, flow rates, temperatures, contamination levels, viscosities, and/or consumption rates; electric current and voltage levels; loading levels (i.e., payload value, percent of maximum allowable payload limit, payload history, payload distribution, etc.); transmission output ratio; cycle time; grade; performed maintenance and/or repair operations; and other such pieces of information. Additional information may be generated or maintained by interface module 18 such as, for example, time of day, date, and operator information. Each of the gathered pieces of information may be indexed relative to the time, day, date, operator information, or other pieces of information to trend the various operational aspects of machine 10.

Operator interface 19 may include a monitor, a touch-screen, a portable hand-held device, a keypad, a control panel, a keyboard, a joystick, a lever, a wheel, and/or another input device. Operator interface 18 may receive input from a machine operator and generate corresponding command signals in response to the input, which may be communicated to controller 22, and/or off-board control system 16 for processing and/or execution.

Additionally, operator interface 19 may include means to identify and/or provide access to authorized machine operators. The identification means may include a switch configured to receive a coded key having magnetic information thereon, a memory chip embedded thereon, a radio-frequency identification circuit (RFID) thereon; a keypad allowing the code to be manually entered by an operator; a data port allowing direct communication with a service tool or a computer having the code; an antenna allowing reception of the code from a remote location; a scanner configured to read coded indicia, or any other configuration that can receive the code and generate a signal indicative of the code. Operator interface 19 may also display data relating to machine status and/or in response to signals from controller 22 and/or off-board control system 16.

Communication module 20 may include any device configured to facilitate communications between controller 22 and off-board control system 16. Communication module 20 may include hardware and/or software that enables communication module 20 to send and/or receive data messages through a wireless communication link 34. The wireless communications may include satellite, cellular, infrared, and any other type of wireless communications that enables controller 22 to wirelessly exchange information with off-board control system 16 and/or the communication modules of other remote machines 10b.

Locating device 21 may be configured to determine and communicate a location of machine 10 to off-board control system 16 and/or controller 22. For example, locating device 21 could include a Global Positioning System (GPS) receiver, an Inertial Reference Unit (IRU), or any other known locating device known in the art.

Controller 22 may include, for example, an electronic control module (ECM), or another processor capable of executing, and/or or outputting command signals in response to received and/or stored data to affect, among other things, the data acquisition discussed herein. Controller 22 may include any means for monitoring, recording, storing, indexing, processing, and/or communicating the operational aspects of machine 10 described above. These means may include components such as, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from types of computer program products or computer-readable media, such as computer chips and secondary storage devices, including hard disks, floppy disks, optical media, CD-ROM, or other forms of RAM or ROM.

Controller 22 may be in communication with the other components of data collection system 14. For example, controller 22 may be in communication with interface module 18, with communication module 20, with locating device 21, and with operator interface 19 via communication lines 36, 37, 38, and 39, respectively. Various other known circuitry may be associated with controller 22 such as, for example, power supply circuitry, signal-conditioning circuitry, solenoid driver circuitry, communication circuitry, and other appropriate circuitry.

Controller 22 may include a calendar database (e.g., tables, matrices, etc.), or another suitable data storage structure(s) in memory to facilitate data acquisition, reporting, and scheduling. The calendar database may include an acquisition entry for each parameter to be monitored by machine 10 (e.g., machine location, oil pressure, hydraulic contamination level, travel speed, current task progress, etc.) in a desired timeslot in the calendar database. For example, Wednesday, Apr. 25, 2007 at 9:00 am may include acquisition entries for hydraulic contamination level and oil pressure. Similarly, every Friday in 2007 at 5:00 pm may include a acquisition entry for current task progress. The calendar database may also include reporting entries at desired timeslots in the calendar database. For example, a reporting entry may be included for every Friday at 5:00 pm.

During machine operation, controller 22 may, among other things, monitor, sample, and/or otherwise track the signals provided by sensing devices 18a-e in accordance with the acquisition entries contained in the calendar database. Particularly, controller 22 may compare an internal machine clock or other associated timing mechanism to the timeslots provided in the calendar database. When a time of the internal machine clock corresponds to a timeslot containing an acquisition entry for a particular operational parameter, controller 22 may determine a value of the parameter, and index and store the parameter value in the timeslot. It is to be appreciated that controller 22 may alternatively or additionally store the parameter value and a corresponding timestamp in a machine operation log or the like contained in memory.

Continuing with the example mentioned above, at 9:00 am on Wednesday, Apr. 25, 2007, controller 22 may store a value for hydraulic contamination level (e.g., moderate) and oil pressure (e.g., 20 psi) in the timeslot. It is to be appreciated that for parameters that may require operator input, such as, for example, current task progress, controller 22 may prompt the machine operator to enter a value for the parameter by way of operator interface 19 (e.g., 2 days to completion, 75% complete, etc), which may then be similarly stored in the appropriate timeslot. It is contemplated that in the event machine 10 is not running or is otherwise unavailable during a timeslot having an acquisition entry, controller 22 may determine a value and/or prompt the operator to enter a value for the particular operational parameter at the next available opportunity (e.g., next time machine 10 is turned on). Alternatively or additionally, controller 22 may determine and store a last known or average value for the parameter.

Controller 22 may also report the values of the parameters contained in the calendar database to off-board system 16 during machine operation. As mentioned above, controller 22 may compare the internal machine clock to the timeslots contained in the calendar database. When a time of the internal machine clock corresponds to a timeslot containing a reporting entry, controller 22 may package and communicate a report to off-board system 16 by way of communication module 20. Specifically, controller 22 may gather the parameter values stored in the calendar database between the current timeslot containing the reporting entry, and a timeslot containing the previous reporting entry. A report containing the parameter values may then be communicated to off-board system 16 for storage.

Continuing with the example mentioned above, on at 5:00 pm on April 30, controller 22 may generate a report containing all of the parameter values stored in the calendar database between the 5:00 pm Mar. 31, 2007 timeslot and the 5:00 pm April 30 timeslot. For example, controller 22 may retrieve or otherwise access the parameter values in the calendar database and/or the machine operation log.

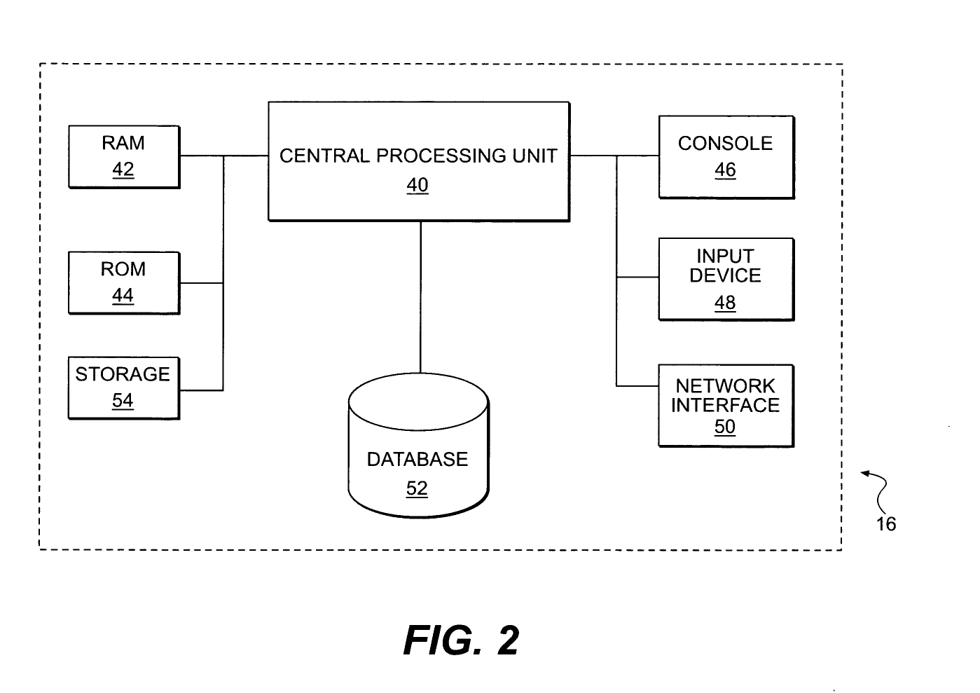

Off-board control system 16 may represent one or more computing systems of a business entity associated with machine 10, such as a manufacturer, dealer, retailer, owner, or any other entity that generates, maintains, sends, and/or receives information associated with the operation of machine 10. The one or more computing systems may include, for example, a laptop computer, a work station, a personal digital assistant, a mainframe, and other computing systems known in the art. As illustrated in the example of FIG. 2, off-board control system 16 may include a central processing unit (CPU) 40, a random access memory (RAM) 42, a read-only memory (ROM) 44, a console 46, an input device 48, a network interface 50, a database 52, and a storage 54. It is contemplated that off-board control system 16 may include additional, fewer, and/or different components than those listed above. It is to be understood that the type and number of listed devices are exemplary only and not intended to be limiting.

CPU 40 may execute sequences of computer program instructions to perform various processes that will be explained below. The computer program instructions may be loaded into RAM 42 for execution by CPU 40 from ROM 44.

Storage 54 may embody any appropriate type of mass storage provided to store information CPU 40 may need to perform the processes. For example, storage 54 may include one or more hard disk devices, optical disk devices, or other storage devices that provide storage space.

Off-board control system 16 may interface with a user via console 46, input device 48, and network interface 50. In particular, console 46 may display information to users of off-board control system 16. Console 46 may be any appropriate type of computer display device or computer monitor. Input device 48 may be provided for users to input information into off-board control system 16. Input device 48 may include, for example, a keyboard, a mouse, or other optical or wireless computer input devices. Further, network interface 50 may provide communication connections such that off-board control system 16 may be accessed remotely through computer networks.

Database 52 may contain model data and any information related to data records and/or reports under analysis. Database 52 may also include analysis tools for analyzing the machine performance information stored within database 52. CPU 40 may use database 52 to determine historic relations or trends relating to fluid consumption rates; machine repair and/or maintenance history; loading, stresses, and/or wear on components of machine 10; hours of use; and other such pieces of real time machine usage information.

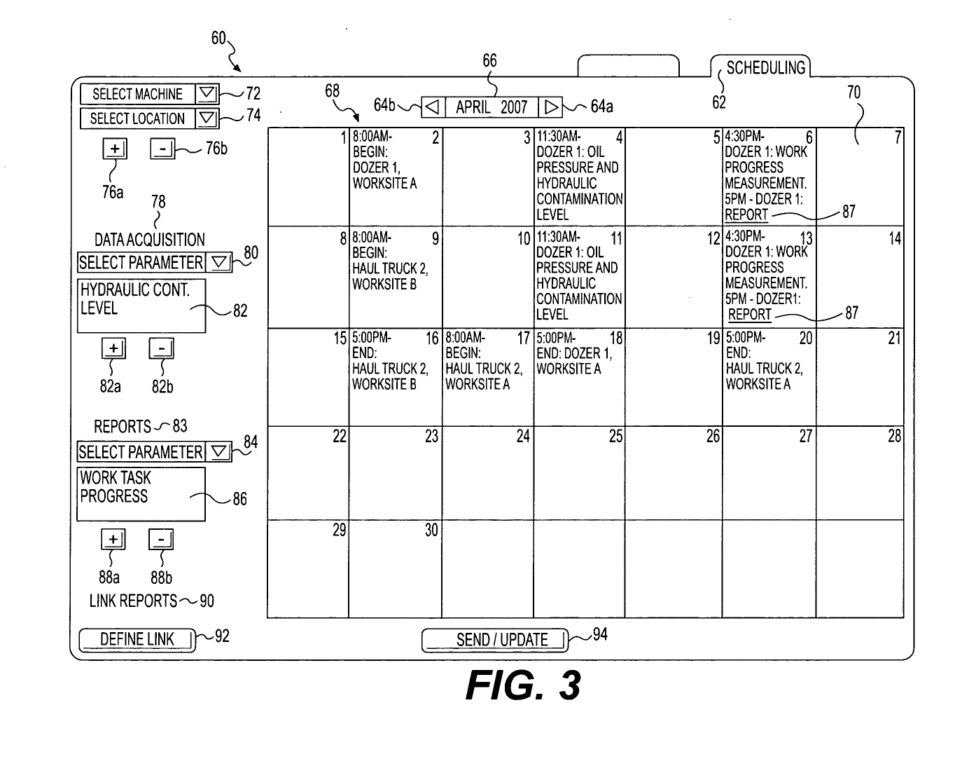

FIG. 3 shows an exemplary graphical user interface (GUI) 60 to implement scheduling of data acquisition and reporting in accordance with this disclosure. It is to be appreciated that GUI 60 may be executed and provided to a user by way of off-board system 16 and/or to a machine operator by way of operator interface 19. That is, GUI 60 be utilized by a user of off-board system 16 to schedule data acquisition and/or reporting operations for one or more remote machines; or by an operator of a machine to schedule data acquisition and reporting of his machine (e.g., machine 10) and/or other remote machines (e.g., machine 10b).

GUI 60 may be a software tool, such as an Internet or dedicated intranet web interface, allowing a user to manage the data acquisition systems of one or more machines (e.g., a fleet). In another example, GUI 60 may be a web interface provided by way of the Internet or a dedicated intranet. GUI 60 may facilitate transmission, reception, and/or retrieval of data, such as reports, operational parameters, settings, and/or other information to and from controller 22, and/or the controllers of other machines (not shown). GUI 60 may include menus (e.g., drop-down menus), modules, buttons, toolbars, and other means to facilitate the transfer of information between off-board system 16 and/or interface 19, and controller 22 and/or other machine controllers. It is to be appreciated that GUI 60 may require user authentication, such as, for example, a username, a password, a pin number, an electromagnetic passkey, etc., which may be entered by way of off-board system 16 and/or interface 19.

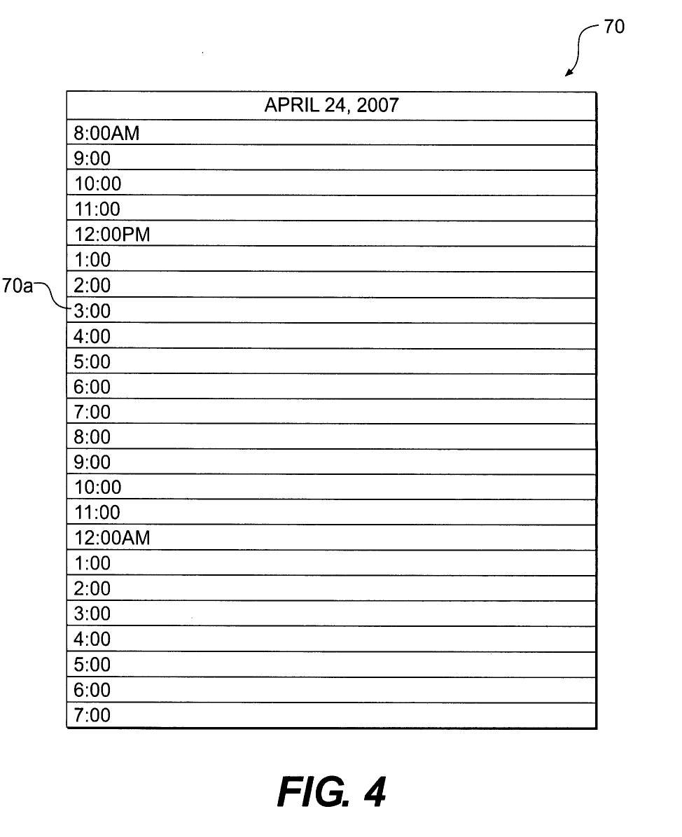

In one embodiment, GUI 60 may include a scheduling feature 62 to facilitate scheduling of data acquisition and/or reporting for machines 10. For example, scheduling feature 60 may include buttons 64a and 64b allowing the user to select a desired month 66. The desired month 66 may be displayed as a calendar interface 68 having a plurality of user-selectable entries 70 each corresponding to a separate day of the month 66. As shown by FIG. 4, entries 70 may include a plurality of selectable timeslots 70a within each day of the month 66 (e.g., hours). Although FIG. 3 shows monthly calendar, it is to be appreciated that calendar interface 68 may alternatively be displayed based a different period of time (e.g., daily, biweekly, yearly, etc.). In one aspect, the period of time may be selectable by the user.

Scheduling feature 62 may include menus 72 and 74 allowing the user to schedule a particular machine (e.g., machine 10b) at a particular location (e.g., worksite A), respectively. For example, the user may click or otherwise select a timeslot 70a of an entry 70 corresponding to a desired start time, and a timeslot 70a of an entry 70 corresponding to a desired end time. In one aspect, upon moving a cursor over or otherwise selecting the entry 70, GUI may display an enlarged view thereof in which the user may select a desired timeslot 70a, as shown by FIG. 4. For example, the user may select machine 10b from menu 72, and select worksite A from menu 74. It is to be appreciated that the particular machines and/or locations available to the user via menus 72 and 74 may be based on a predetermined profile associated with the user. In other words, the user may only have access to machines and locations that the user is authorized to access.

The user may then schedule machine 10b at worksite A between the desired start time and the desired end time by clicking add button 76a. The scheduling may then be displayed in the appropriate timeslots 70a in entry 70 on calendar interface 68. Similarly, the scheduling may be removed from calendar interface 68 by pressing remove button 76b. It is to be appreciated, however, that the user may alternatively or additionally schedule by selecting the machine and worksite from menus 72 and 72, respectively, and “dragging and dropping” them onto a desired entry 70 on calendar interface 70. Likewise, the scheduling may be removed by “dragging” the scheduling from calendar interface 70. Other known methods of selection may be used, if desired.

Scheduling feature 62 may also include a tool 78 allowing the user to schedule when data acquisition on a particular machine is to take place. For example, the user may select a timeslot 70a of an entry 70 on calendar interface 68 corresponding to a desired point in time for data acquisition. The user may then select machine 10b from menu 72, and one or more desired parameters (e.g., hydraulic contamination level, current task progress, etc.) from menu 80 to add to list 82. When all desired parameters for the given machine have been added to list 82, the user may schedule the data acquisition at the selected time by clicking add button 82a. Likewise, the user may remove the scheduled data acquisition by clicking remove button 82b. Alternatively or additionally, “dragging and dropping” gestures may be used to schedule and/or remove scheduled data acquisition, as discussed above.

Scheduling feature 62 may further include a tool 83 allowing the user to schedule reporting of parameters from a desired machine. For example, the user may select a desired timeslot 70a of an entry 70 on calendar interface 68 corresponding to a desired point in time for machine parameter reporting. The user may then select a desired machine (e.g., machine A) from menu 72. The user may then select from menu 84 and add to list 86 any desired parameters (e.g., hydraulic contamination level, current task progress, a full diagnostic report, etc.) to be reported at the selected time. A report comprising the selected parameters may be scheduled and/or removed by clicking add 88a and remove 88b buttons, respectively, and/or “dragging and dropping,” as discussed above. Calendar interface 68 may be responsively updated as to reflected the scheduled reporting. Upon receipt of a report from a machine, a link (e.g., a link to an Internet or intranet page, a downloadable file, etc.) may become available allowing the user to view the report. In one example, the text, “Report,” may become a text link 87 the user may click or otherwise select after the report has been received.

Scheduling feature 62 may also include an option 90 allowing the user to link reporting of two or more machines 10. This feature may be useful in a situation where two or more machines are required to work in tandem or when the operation of a first machine is dependent on the operation of a second machine and/or additional machines. As such, linking option 90 may allow the user to create one or more dependency definitions to regulate the manner in which machine reports are executed. A dependency definition may include one or more user-set conditions that, when met, trigger a predefined action (i.e., requesting the data report from second machine 10a, and/or scheduling second machine 10a at a desired time and location). For example, the user may create dependency definition wherein a data report from second machine 10a is requested only if a data report is received from first machine 10b indicating that current task progress is greater than 75%. The dependency definition may further require a current work task progress contained in the data report from second machine 10a be complete (e.g., 100%) before scheduling second machine 10a at a desired time and/or location.

Upon receiving a report from a machine, off-board control system 16 may compare data in the report to the one or more predetermined and/or user-set dependency definitions to determine whether the one or more definitions have been satisfied. If so, off-board system 16 may then request a data report from the second or subsequent machines. A data report may not be requested from second machine 10a until a dependency definition is satisfied. Additionally, off-board control system 16 may then compare data in the report received from second machine 10a to one or more dependency definitions, and schedule second machine 10a at a desired time and location if the one or more definitions are satisfied.

In one example, the first machine could be the dozer 10b illustrated in FIG. 1, while the second machine could be the haul truck 10a. Haul truck 10a could be scheduled to work at a common work site with dozer 10b, but only after dozer 10b has gathered enough material to load haul truck 10a. While dozer 10b gathers the material to load into haul truck 10a, haul truck 10a may be efficiently tasked to a second site. In this instance, after receiving a data report from dozer 10b indicating that the appropriate amount of material has been gathered, a report from haul truck 10a may be requested to determine the progress or location of haul truck 10a at the second site. In this manner, haul truck 10a may be redirected to the original task of removing the overburden material at the appropriate time with respect to the progress of dozer 10b, but only after efficiently completing the additional task at the second site. By only requesting a data report from haul truck 10a after the report from dozer 10b has been received, the number of communications and computing processes may be kept to a minimum.

In another example, the user may create a dependency definition wherein a fuel tanker (not shown) is tentatively scheduled to work at the location of first machine 10b. The definition may a request a data report from the fuel tanker (not shown), including a geographical location thereof (e.g., global position) and a current task progress, on the condition that a data report has been received from first machine 10b indicating that a fuel level thereof has dropped below 40%. The scheduling of the fuel tanker at the location of first machine 10b may be further contingent on the fuel tanker being within 15 miles of the location of the first machine, at least one additional machine (not shown) having a fuel level of 40% or less, and a current task progress of the tanker being complete.

For example, the user may click or otherwise select a timeslot 70a of an entry 70 corresponding to a desired start time, and a timeslot 70a of an entry 70 corresponding to a desired end time. The user may then select a first machine (e.g., haul truck 10a) from menu 72, and worksite A from menu 74. The user may then click define link button 92. The user may then be prompted to define a first condition including a parameter and a value thereof for the first machine (e.g., work task progress of 100%) to be satisfied. The user may similarly define a second condition for a second, previously-scheduled machine (e.g., dozer 10b), including one or more parameters and values thereof to be satisfied. For example, the user may select dozer 10b, a work task progress of 75%, and a date and/or time by which the condition must be satisfied. The user may similarly add to the definition additional conditions to be satisfied. During operation, the first machine may be scheduled at the desired worksite between the selected start and end times only if all the defined conditions are satisfied.

Scheduling feature 62 may also include a button 94 to send the scheduling changes to the appropriate machines 10. That is, upon clicking button 94, data acquisitions and reports previously scheduled may be communicated to machines affected by any of the scheduling operations mentioned above. Controller 22 may then update the calendar database to include data acquisition entries and reporting entries in accordance calendar interface 68. Upon receiving a report from one of machines 10 off-board system 16, may index and/or store the report in database 52 and insert a link to the report in entry 70 on calendar interface 68.

One skilled in the art will realize that the processes illustrated in this description may be implemented in a variety of ways and include other modules, programs, applications, scripts, processes, threads, or code sections that may all functionally interrelate with each other to accomplish the individual tasks described above for each module, script, and daemon. For example, these programs modules may be implemented using commercially available software tools, using custom object-oriented code written in the C++ programming language, using applets written in the Java programming language, or may be implemented with discrete electrical components or as one or more hardwired application specific integrated circuits (ASIC) that are custom designed for this purpose.

The described implementation may include a particular network configuration but embodiments of the present disclosure may be implemented in a variety of data communication network environments using software, hardware, or a combination of hardware and software to provide the processing functions.

### INDUSTRIAL APPLICABILITY

The disclosed methods and systems may provide ways to efficiently collect and report machine operational data. In particular, the disclosed methods and systems allow a user to intuitively schedule data collection and reporting by way of a calendar interface. In this manner, the cost and complexity of computing resources and the number of communications required may be reduced. Usage of GUI 60 will now be explained.

In one aspect, an authorized user of off-board system 16 or an authorized machine operator (hereinafter “user”) may log in or otherwise access GUI 60 by way of off-board system 16 and/or interface 19. As mentioned above, GUI 60 may be utilized by a user of off-board system 16 to schedule data acquisition and/or reporting operations for one or more remote machines; or by an operator of a machine to schedule data acquisition and reporting of his machine (e.g., machine 10) and/or other remote machines (e.g., machine 10b). The user may then access scheduling feature 62. Once scheduling feature 62 has been properly accessed, calendar interface 68 may be displayed. The user may then select a desired month 66 (e.g., “April 2007”) by way of buttons 64a and 64b.

In one example, the user may wish to schedule dozer 10b on worksite A from 8:00 am on April 2 to 5:00 pm on April 18 for a material-gathering task. As such, the user may click or otherwise select timeslots 70a corresponding to April 2 at 8:00 am and April 18 at 5:00 pm. The user may then select dozer 10b from menu 72, and worksite A from menu 74. The user may then schedule the task by clicking add button 76. In response, calendar interface 68 may be updated to include the scheduling. For example, an entry 70 corresponding to Apr. 2, 2007 may display “8:00 am—Begin: dozer 1, worksite A”, and an entry 70 corresponding to Apr. 18, 2007 may display “5:00 pm—End: dozer 1, worksite A,” as shown in FIG. 3 Calendar interface 68 may also display highlighting, coloring, or otherwise visually indicate the intermediate days dozer 10b is scheduled to work on worksite A (e.g., an arrow going from April 2 to April 18).

Subsequently, the user may wish to schedule data acquisition for dozer 10b. For example, the user may wish to have dozer 10b collect oil pressure and a hydraulic contamination level on April 4^{th} and April 11^{th} at 11:30 am. The user may also wish to have work task progress measurements collected on April 6^{th} and April 13^{th} at 4:30 pm. As such, the user may schedule the desired data collection by way of menus 72 and 80, and button 84. In response, calendar interface 68 may be updated to include the scheduled data collection. For example, entries 70 corresponding to April 4^{th} and 11^{th} may display “Dozer 1: oil pressure, and hydraulic contamination level,” as shown in FIG. 3. Entries 70 corresponding to April 6^{th} and April 13 may similarly display “Dozer 1: work progress measurement,” as shown by FIG. 3.

The user may also wish to schedule a report for dozer 10b. For example, the user may desire a report containing one or more parameters collected by dozer 10b on April 6^{th} and 13^{th} at 5:00 pm. As such, the user may schedule the reports by way of menus 72 and 88, as discussed above. In response, calendar interface 68 may be updated to include the scheduled reports. For example, entries 70 corresponding to April 6^{th} and 13^{th} may display “5:00 pm—Dozer 1, Report.” Upon receipt of a report from dozer 10b, a selectable link (e.g., a link to an Internet or intranet page, a downloadable file, etc.) may become available allowing the user to view the report. In one example, “Report” may become a text link the user may click on or otherwise select upon receipt of the report. In another aspect, the report itself may be displayed in the appropriate entry 70. Further, an electronic mail message containing the report may be generated and sent to an account of the user associated with the particular machine 10. Other means of visually providing the report to the user may be used, if desired.

Subsequently, the user may wish to schedule haul truck 10a at another location from April 9^{th} at 8:00 am to April 16^{th} at 5:00 pm. The user may also wish to schedule data acquisition and reporting for truck 10a. The user may schedule these events as discussed above, and calendar interface 68 may be appropriately updated as shown by FIG. 3. Additionally, the user may wish to tentatively schedule haul truck 10a at the first location with dozer 10b for a material-removal task from 8:00 am on April 17^{th} to 5:00 pm on April 20^{th} contingent on dozer's 10b completion of at least 75% of its material-gathering task by 5:00 pm on April 13^{th}, and haul truck's 10a completion of its previous task (e.g., task is 100% complete). As such, the user may select timeslots 70a corresponding to the desired start time and end time for the tentative haul truck material-removal task. The user may then select haul truck 10a from list 72, and click the define link button 92, and create an appropriate dependency definition as discussed above. During operation, calendar interface 68 may be updated as to reflect the scheduling of haul truck 10a if the dependency definition(s) are satisfied. For example, the entries 70 corresponding to April 17^{th} and April 20^{th} may display “8:00 am—Begin: Haul Truck 2, Worksite A,” and “5:00 pm—End: Haul Truck 2, Worksite A,” as shown in FIG. 3.

Upon completion of all desired scheduling, the user may click the send/update button 104 in order to update the effected machines 10, as discussed above.

In some instances, the user may wish to view past reports by way of calendar interface 68 for diagnostic or analysis purposes. The user may scroll through or otherwise select prior months 66 by way of buttons 64a and 64b and/or entering a desired month and year. Calendar interface 68 may display links 87 to reports communicated to off-board system 16 in the past within appropriate corresponding entries 70. Upon locating a desired report for a particular machine, the user may click the link to view the report, as mentioned above.

By employing the disclosed data acquisition system and GUI, efficient machine scheduling, data acquisition, and reporting may be accomplished. The calendar interface may allow a user to intuitively schedule the times at which the machines collect and transmit data to the off-board system. In this manner, continuous, add-hoc, and/or unnecessary data collection and transmission may be avoided, and valuable bandwidth and processing resources may be conserved, reducing manufacturing and operational costs. Further, by allowing the user to intuitively view historical reports transmitted by the machines, the user may be better able to track, trend, and/or analyze usage of the machines.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A data acquisition system, comprising:
one or more remote machines; and
an off-board system in communication with the one or more remote machines, the off-board system being configured to:
display a calendar interface having a plurality of selectable entries each corresponding to a different period of time;
receive a user's selection of one of the plurality of selectable entries corresponding to a desired period of time. receive a user's selection of one of the one or more remote machines;
receive a user's selection of one of a plurality of available operational parameters monitored by the selected one of the one or more remote machines; and
update a configuration of the selected one of the one or more remote machines based on the desired period of time and the selected one of a plurality of available operational parameters.

2. The data acquisition system of claim 1, wherein the selected one of the one or more remote machines is configured to transmit a value of the selected one of a plurality of available operational parameters to the off-board system during the desired period of time in response to the update.

3. The data acquisition system of claim 2, wherein the off-board system is further configured to generate a report including a value of the selected one of a plurality of available operational parameters for viewing by the user.

4. The data acquisition system of claim 3, wherein the report includes an electronic mail message transmitted during the desired period of time.

5. The data acquisition system of claim 3, wherein the off-board system is further configured to display a link corresponding to the report on the calendar interface, wherein the report is viewable upon the user's selection of the link.

6. The data acquisition system of claim 1, wherein the off-board system is further configured to:
receive a user's selection of an elapsed period of time; and
display links on the calendar interface corresponding to reports transmitted to the off-board system during the elapsed period of time, wherein the reports are viewable upon the user's selection of the links.

7. The data acquisition system of claim 1, wherein the selected one of the one or more machines machine is configured to collect data corresponding to the selected one of a plurality of available operational parameters during the desired future period of time in response to the update.

8. The data acquisition system of claim 7, wherein the selected one of the one or more machines is further configured to store a value of the selected one of a plurality of available operational parameters in a machine operation log during the desired period of time in response to the update.

9. The data acquisition system of claim 1, wherein a total amount of time displayed on the calendar interface is selectable by a user and includes one or more of a year, a month, a week, a bi-week, a day, and an hour.

10. A local machine, comprising:
a power source configured to power operations of the local machine;
an operator interface to receive input from and provide information to an operator of the local machine; and
a controller in communication with the operator interface and one or more remote machines, the controller being configured to:
display a calendar interface having a plurality of selectable entries each corresponding to a different period of time;
receive the operator's selection of a one of the plurality of selectable entries corresponding to a desired period of time;
receive the operator's selection of the local machine or one of the one or more remote machines;
receive the operator's selection of one of a plurality of available operational parameters monitored by the selected local machine or the selected one of the one or more remote machines; and
update a configuration of the selected local machine or the selected one of the one or more remote machines based on the desired period of time and the selected one of a plurality of operational parameters.

11. The local machine of claim 10, wherein the selected local machine or the selected one of the one or more remote machines is configured to collect data corresponding to the selected one of a plurality of operational parameters during the desired period of time in response to the update.

12. The local machine of claim 11, wherein the selected local machine or the selected one of the one or more remote machines is further configured to store a value of the selected one of a plurality of operational parameters in a machine operation log in response to the update.

13. The local machine of claim 10, wherein the selected local machine or the selected one of the one or more remote machines is configured to communicate a value of the selected one of a plurality of operational parameters to an off-board system during the desired period of time in response to the update.

14. The local machine of claim 10, wherein the controller is further configured to:
receive an operator's selection of a desired elapsed period of time; and
display links on the calendar interface corresponding to reports transmitted to the off-board system during the elapsed period of time, wherein the reports are viewable upon the operator's selection of the links.

15. The local machine of claim 10, wherein a total amount of time displayed on the calendar interface is selectable by an operator and includes one or more of a year, a month, a week, a bi-week, a day, and an hour.

16. A method of acquiring data, comprising:
displaying a calendar interface having a plurality of selectable entries each corresponding to a different period of time;
receiving a selection of a one of the plurality of selectable entries corresponding to a desired period of time;
receiving a selection of one of the one or more remote machines;
receiving a selection of one of a plurality of available operational parameters monitored by the selected one of the one or more remote machines; and
updating a configuration of the selected one of the one or more remote machines based on the desired period of time and the selected one of a plurality of available operational parameters.

17. The method of claim 16, further including transmitting, by the selected one of the one or more remote machines, a value of the selected one of a plurality of available operational parameters to an off-board system during the desired period of time in response to the update.

18. The method of claim 16, further including collecting, by the selected one of the one or more remote machines, data corresponding to the selected one of a plurality of available operational parameters only during the desired period of time in response to the update.

19. The method of claim 18, further including storing, by the selected one of the one or more remote machines, a value of the selected one of a plurality of available operational parameters in a machine operation log.

20. The method of claim 16, further including:
selecting an entry corresponding to an elapsed period of time; and
displaying links on the calendar interface corresponding to reports received during the elapsed period of time, wherein the reports are viewable upon selection thereof.
